(19) United States
(12) Patent Application Publication
(10) Pub. No.: US 2017/0059968 A1
(43) Pub. Date: Mar. 2, 2017

(54) HAND-HELD ARTICULATING ARM CAMERA MOUNT

(71) Applicant: EVOKE INNOVATIVE SOLUTIONS INC., El Segundo, CA (US)

(72) Inventor: Reno Makani MALTESE, El Segundo, CA (US)

(73) Assignee: EVOKE INNOVATIVE SOLUTIONS INC., El Segundo, CA (US)

(21) Appl. No.: 15/308,564

(22) PCT Filed: Apr. 30, 2015
(86) PCT No.: PCT/US15/28649

§ 371 Date: Nov. 2, 2016

Related U.S. Application Data
(60) Provisional application No. 61/988,113, filed on May 2, 2014.

(51) Int. Cl. G03B 17/56; F16M 11/06; F16M 13/04

(52) U.S. Cl. CPC G03B 17/561; F16M 13/04; F16M 11/06; G03B 17/563

(57) ABSTRACT

The present disclosure provides a hand-held camera mount for mounting an imaging device. In one embodiment, a hand-held imaging device mount comprises a handle configured to be held by a user; a base connected to the handle; an arm movably secured to the base such that the arm can be rotated relative to the handle and secured in place; and a mount head movably secured to the arm such that the mount head can be moved relative to the arm and secured in place, the mount head configured to mount an imaging device, wherein the imaging device mount permits an imaging device mounted to the mount head to be adjusted with multiple degrees of freedom relative to the handle.

### CROSS-REFERENCE TO RELATED APPLICATION

The present application claims priority to U.S. Provisional Application No. 61/988,113, entitled “Hand-Held Articulating Arm Camera Mount,” filed on May 2, 2014, the entire contents of which are herein incorporated by reference as if fully set forth herein.

### TECHNICAL FIELD

The present application relates generally to camera mounting devices, and, more particularly, to a hand-held mount having articulating or extendable arms for mounting an imaging device.

### SUMMARY OF THE INVENTION

The present disclosure may be embodied in a hand-held imaging device mount for mounting an imaging device. The mount may comprise a handle configured to be held by a user; a base connected to the handle; an arm movably secured to the base such that the arm can be rotated relative to the handle and secured in place; and a mount head movably secured to the arm such that the mount head can be moved relative to the arm and secured in place, the mount head configured to mount an imaging device. The imaging device mount permits an imaging device mounted to the mount head to be adjusted with multiple degrees of freedom relative to the handle.

In one aspect of this embodiment, the arm may comprise a plurality of segments that are movably secured to each other to form the arm.

In another aspect of this embodiment, the handle may comprise a high-friction material for assisting a user in holding the handle, such as a rubber material.

At least one of the arm and mount head may be movably secured using a threaded fastener such that when the threaded fastener is loosened, the arm and/or mount head is movable, and when the threaded fastener is tightened, the arm and/or mount head is secured in place.

In a particular aspect, of this embodiment, the mount head may be configured to mount a GoPro camera.

In another aspect of this embodiment, the handle may be removably connected to the base. In a more particular embodiment, the base may comprise an elongated body, and the handle may comprise an opening shaped to receive the elongated body, and a clamp to secure the handle to the base. The handle may be removably connected to the base by inserting the elongated body into the opening and closing the clamp, and may be removed by opening the clamp.

In another embodiment, the hand-held imaging device mount for mounting an imaging device may comprise: a handle configured to be held by a user; an arm extending from the handle, the arm comprising a plurality of extending segments; and a mount head movably secured to the arm such that the mount head can be moved relative to the arm and secured in place, the mount head configured to mount an imaging device. The plurality of extending segments may be extended relative to each other and secured in place.

The present disclosure may also be embodied in a method comprising: mounting an imaging device to a mount, the mount comprising a handle configured to be held by a user, a base connected to the handle, an arm movably secured to the base such that the arm can be rotated relative to the handle and secured in place, and a mount head movably secured to the arm such that the mount head can be moved relative to the arm and secured in place, the mount head configured to mount an imaging device; adjusting the position of the imaging device in a first direction by adjusting the position of the arm relative to the base; adjusting the position of the imaging device in a second direction that is different from the first position by adjusting the position of the mount head relative to the arm; and locking the imaging device in place.

The mount used in the method may comprise any of the various aspects of the mount disclosed with respect to the previous embodiments.

In a particular aspect of this embodiment, adjusting the position of the imaging device in a first direction by adjusting the position of the arm relative to the base may comprise pivoting the arm relative to the base. Further, adjusting the position of the imaging device in a second direction that is different from the first direction by adjusting the position of the mount head relative to the arm may comprise pivoting the mount head relative to the arm and/or rotating the mount head relative to the arm.

In another aspect of this embodiment, the base may be removably connected to the handle. The base may comprise an elongated body and the handle may comprise an opening shaped to receive the elongated body, and a clamp to secure to the handle to the base. The method may further comprise loosening the clamp; and removing the handle from the base.

These and other features and advantages of the invention should become more readily apparent from the detailed description of the preferred embodiments set forth below taken in conjunction with the accompanying drawings, which illustrate, by way of example, the principles of the invention.

### BRIEF DESCRIPTION OF THE DRAWINGS

The drawings are provided for purposes of illustration only and merely depict typical or example implementations. These drawings are provided to facilitate the reader's understanding and shall not be considered limiting of the breadth, scope, or applicability of the disclosure. For clarity and ease of illustration, these drawings are not necessarily drawn to scale.

FIG. 1 provides a perspective view of a hand-held articulating arm camera mount in accordance with an embodiment of the present disclosure.

FIGS. 2A and 2B provide close-up views of the handle, base, and pivot arm of the hand-held articulating arm camera mount of FIG. 1.

FIGS. 3A, 3B, and 3C provide close-up views of the head assembly of the hand-held articulating arm camera mount of FIG. 1.

FIG. 4A provides a perspective view of a modular handle, in accordance with an aspect of an embodiment of the present disclosure.

FIG. 4B provides a close-up view of the top end of the modular handle of FIG. 4A.

FIG. 4C provides a close-up view of the bottom end of the modular handle of FIG. 4A.

FIG. 4D provides another perspective view of the modular handle of FIG. 4A.

FIG. 5 provides a perspective view of a monopod hand-held arm camera mount in accordance with another embodiment of the present disclosure.

FIG. 6A provides an exploded view of an alternative embodiment of a modular handle.

FIG. 6B provides a perspective view of the modular handle of FIG. 6A.

### DETAILED DESCRIPTION

The present disclosure is directed towards a hand-held mount 10 for mounting an imaging device. Compact, sturdy imaging devices, such as the GoPro line of cameras, have become extremely popular, allowing users to capture unique views and perspectives of their activities by strapping the camera to their helmet or other equipment. However, the mounts available for these types of cameras have been fairly limited, and have not allowed for the degree of creativity and freedom of movement that is achievable with these compact imaging devices.

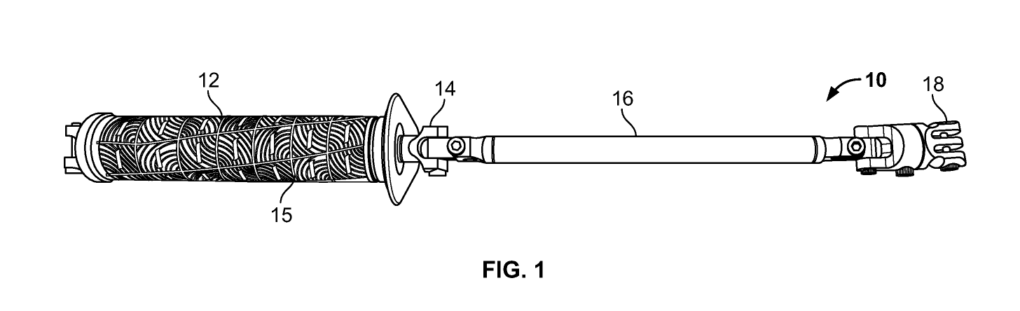

The mount 10 shown in FIG. 1 allows for a camera to be positioned in many different positions by providing pivot points that allow for multiple dimensions of movement. The mount comprises a handle 12, a base 14, a pivot arm 16, and a head assembly 18. The base 14 is mounted to the handle 12, the pivot arm 16 is mounted to the base 14 such that it can pivot about the base 14, and the head assembly 18 is mounted to the pivot arm 16 such that it can pivot about the pivot arm. The opposite end of the head assembly 18 is shaped so as to be able to mount a camera or other imaging device. Preferably, the materials used to make the described pieces are made of durable, sturdy materials that can withstand weather and the elements. The handle 12 may comprise a rubber material or any other material that assists a user in holding the mount 10.

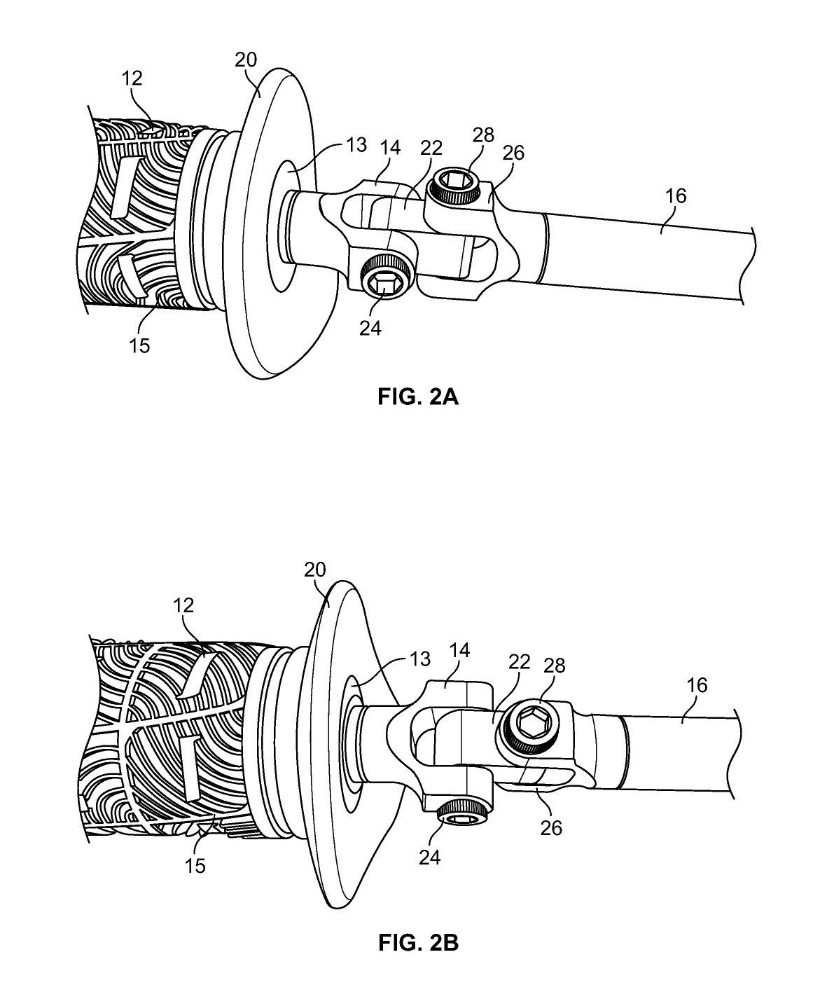

Close-up views of the handle 12, the base 14, and the pivot arm 16 are shown in FIGS. 2A and 2B. The handle 12 is covered in a high-friction rubber material so as to make it easier for a user to grip the handle 12. The handle 12 has a cross-guard 20, which also assists the user in gripping the handle 12 by preventing the user's hand from moving past the cross-guard 20. The base 14 is securely mounted to the handle 12. In the embodiment shown in FIGS. 2A-2B, the base 14 may comprise an end portion 13 that is inserted into an opening in the handle 14 and secured in place (possibly via an adhesive or other securing mechanism).

The base 14 is a U-shaped clevis that is configured to receive the pivot arm 16 such that it is able to pivot about the base 14. In the depicted configuration, the base 14 is connected to a first end of the pivot arm 16 via an intermediate tang 22, which is rotatably secured to the base 14 using a screw 24. The opposite end of the tang 22 is inserted into a clevis-end 26 of the pivot arm 16, and rotatably secured using a second screw 28. When the screws 24, 28 are fully tightened, the pivot arm 16 is tightly secured to the base arm 14 and is held in place. When the screws 24, 28 are loosened, the pivot arm 16 is able to pivot in a direction perpendicular to the loosened screw. The depicted configuration allows for the pivot arm 16 to pivot in two directions, allowing a user to position the pivot arm 16 in a variety of positions.

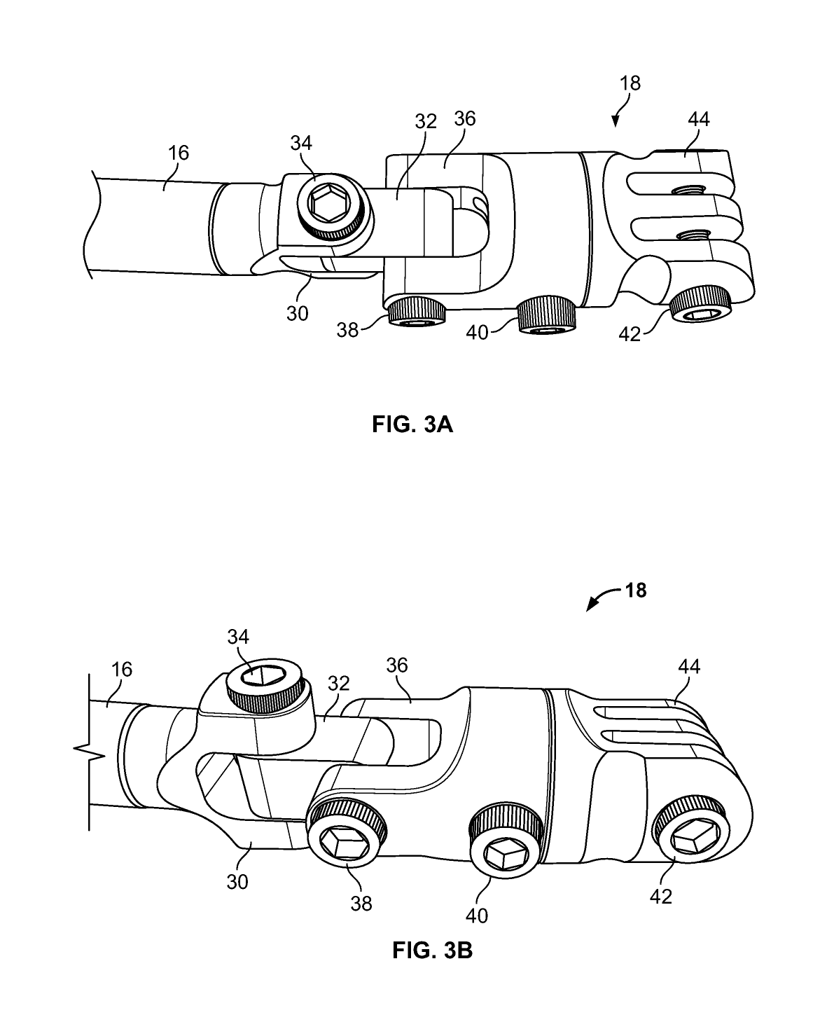

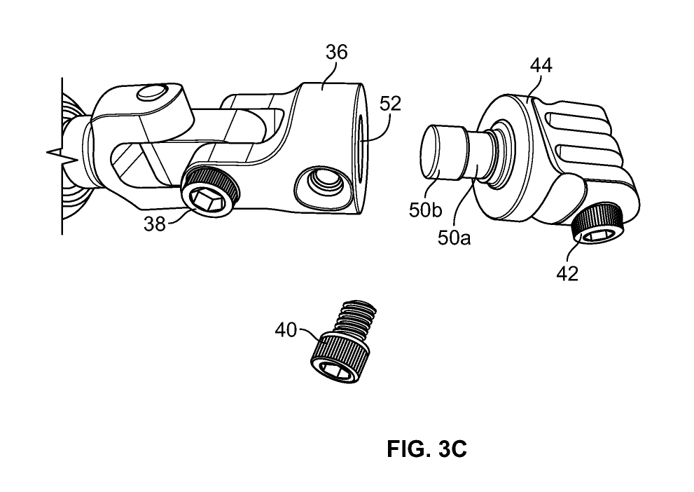

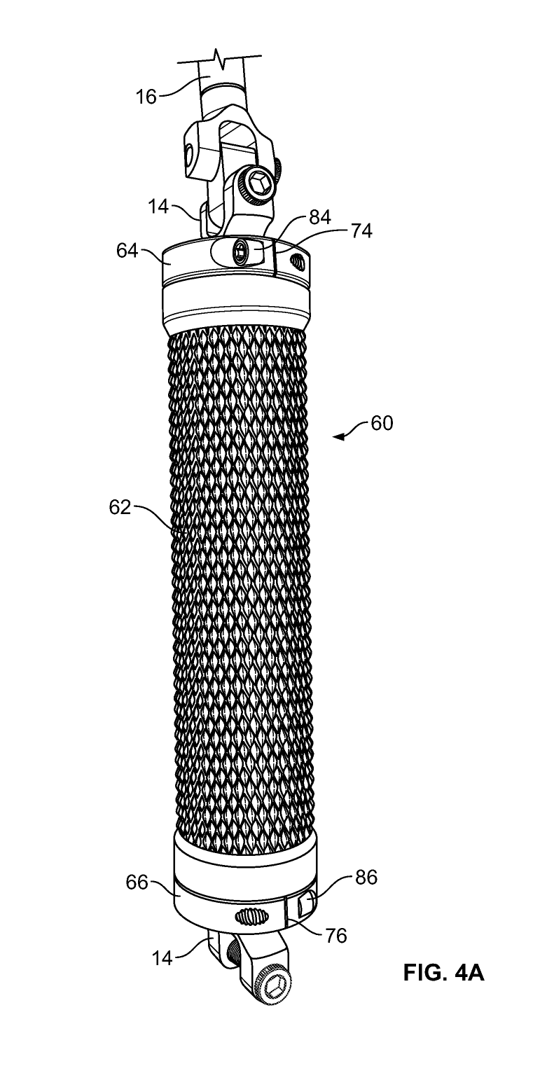

FIGS. 3A and 3B provide close up views of the opposite end of the pivot arm 16, which is connected to the head assembly 18. The head assembly 18 is mounted to the pivot arm 16 in a configuration similar to the pivot arm 16 and base 12, shown in FIG. 2. The pivot arm 16 has a clevis end 30 that receives a tang 32, and they are secured together using a screw 34. The head assembly 18 comprises a head base 36, which also has a clevis end that receives the tang 32 and these are secured together using a screw 38. The head assembly further comprises a mount head 44 that is secured to the head base 36.

The mount head 44, part of the head assembly 18, is the piece of the mount 10 that is configured to receive a camera or other imaging device. The head 44 shown in the figures is a head designed to receive a Go-Pro camera, but the head 44 may be configured to receive any kind of camera. As described above, screw 34 is used to connect the pivot arm 16 to the head assembly 18 in a clevis-fastener configuration. When the screw 34 is loosened, the head assembly 18 is able to pivot on an axis perpendicular to the screw 34. When the screw 34 is tightened, this joint is secured and does not move. The second screw from the left (38) controls the complementary joint that allows for movement in the perpendicular direction from the joint just described. These two joints/screws 34, 38 allow for movement in perpendicular directions, which allows for significant flexibility in the positioning of the mounted camera. The rightmost screw 42 is used to secure the camera to the camera head 44.

The second screw from the right (40) controls rotation of the camera or imaging device. When the screw 40 is loosened, the mount head 44 is able to rotate, thereby allowing for the camera to be rotated around. Tightening of the screw 40 locks the rotation of the camera. Further, as depicted in FIG. 3C, when the screw 40 is loosened to an even further degree, or removed altogether, head 44 may be separated from the head base 36. In the depicted embodiment, the mount head 44 has a column having a narrow portion 50a and a raise portion 50b that is configured to be inserted into a corresponding opening 52 in the head base 36. When the column is inserted into the opening 52, the screw 40 is tightened to come into contact with the narrow portion 50a. The contact between the screw 40 and the narrow portion 50a controls rotation of the mount head 44. The raised portion 50b controls removal of the mount head 44 from the head base 36. When the screw 40 is tightened, it comes into contact with the top ridge of the raised portion 50b and prevents the column 50 from being removed from the opening 52. When the screw 40 is significantly loosened or removed altogether, the mount head 44 may be separated from the head base 36. By making the mount head 44 removable, a user may replace the mount head 44 while using the same mount, allowing for greater flexibility in the types of devices that may be secured to the mount 10.

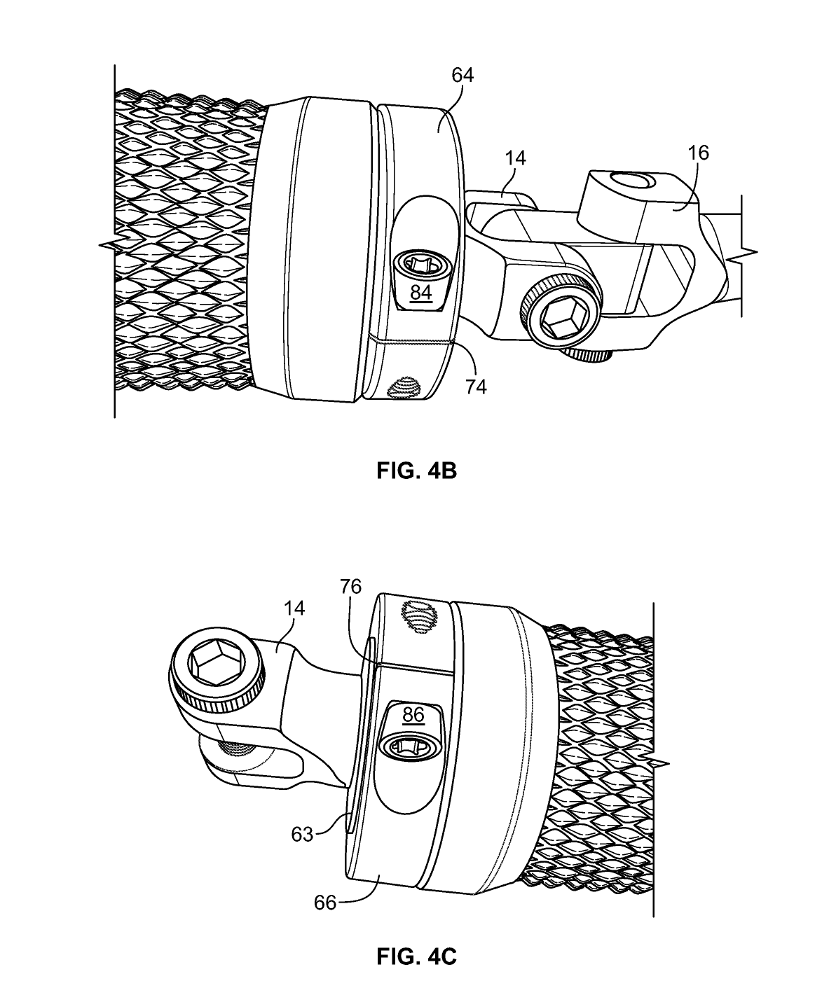

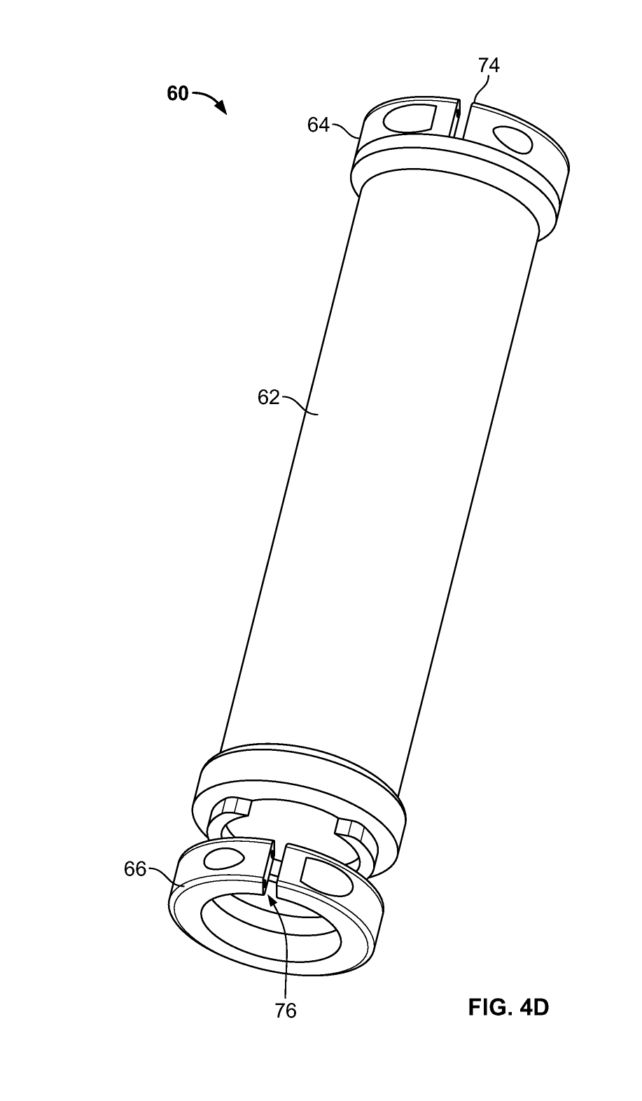

FIG. 4A depicts a modular handle 60 that may be used with the mount 10 described above. The modular handle 60 includes a handle portion 62, a top clamp 64, and a bottom clamp 66. As with the handle 12 in FIG. 1, the modular handle 60 is secured to a base 14, which is then secured to the pivoting arm 16. In this embodiment, the base 14 is elongate in shape and extends all the way through the modular handle 60 and out the other end. The modular handle 60 is a hollow cylinder that slides over the base 14. The modular handle 60 is secured to the base 14 via clamps 64 and 66. Each clamp 64, 66 has a slit 74, 76, which is tightened using a screw 84, 86. Close-up views of the top clamp 64 and the bottom clamp 66 are shown in FIGS. 4B and 4C, respectively. When the screws 84, 86 are loosened, the clamps 64, 66 loosen, and the modular handle 60 can be slid off the base 14. FIG. 4D provides a perspective view of the modular handle 60 that is removed from the base 14. The removable nature of the modular handle 60 allows users to easily change the modular handle 60. This feature provides the advantages of making the modular handle 60 easily replaceable (for example, to replace a worn out or damaged handle), allowing users to substitute handles with different materials, patterns or colors based on user preference or situational need, and/or allowing users to change the handle to fit to their personal ergonomic preference or need.

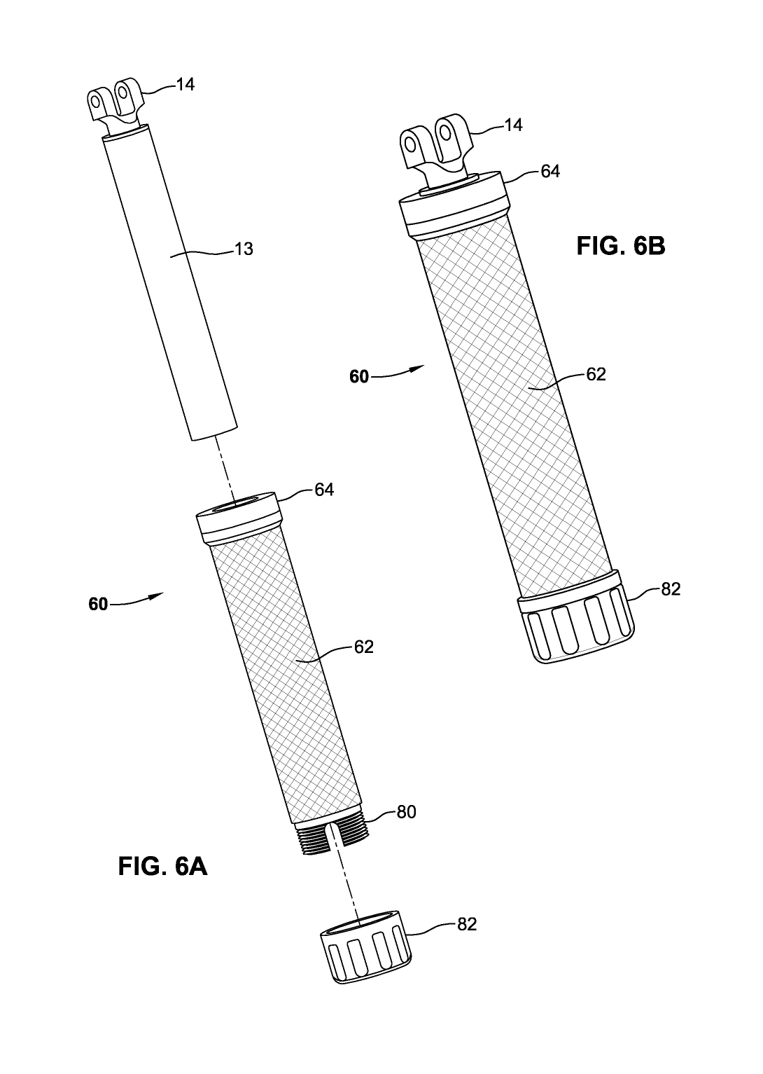

FIGS. 6A and 6B provide exploded and perspective views, respectively, of another embodiment of a modular handle. In FIG. 6A, it can be seen that the base 14 with an elongated portion 13 is inserted into the modular handle 60. The modular handle 60 may have a handle portion 62 that comprises a high friction material to assist as user in gripping the handle portion 62. Inside the handle portion 62, there may be an inner structural element that gives added structure and stability to the handle portion 62 and allows for easy insertion of the base 14 and elongated portion 13. In the embodiment shown, for example, the structural element may be a hollow cylinder made of a solid material such as plastic or polycarbonate that makes up the inner portion of the handle portion 62.

Similar to what was seen in FIGS. 4A-4B, a clamp 64 position on the top of the handle 60 secures the top portion of the handle 60 to the base 14. However, on the bottom of the handle 60, rather than another clamp, a threaded fastener 80 is provided to receive an end cap 82. As the end cap 82 is screwed onto the threaded fastener 80, the threaded fastener 80 is compressed and tightened around the elongated portion 13 of the base 14. As such, the bottom portion of the handle 60 is secured around the base 14. FIG. 6B provides a perspective view of the entire handle in an assembled state. In certain embodiments, the elongated portion 13 may be a hollow cylinder with an opening on the bottom portion such that the handle 60 and base 14 may act as a storage compartment.

The depicted mount 10 allows for considerable flexibility in position of a mounted camera by allowing the pivot arm 16 to move in two directions relative to the base 14, and the head 18 to move in two directions relative to the pivot arm 16, as well as allowing the head 18 to rotate. In this way, a user is able to capture unique perspectives and angles with a mounted imaging device, while comfortably holding the entire configuration using the handle 12. It should also be understood that while a particular embodiment has been depicted and described with respect to the figures, other similar embodiments fall within the present disclosure. For example, while alien screws have been used to secure handles and clevis-type configurations at each of the joints depicted, alternative types of joints and securing mechanisms may be used to achieve similar results. Also, additional pivot arms 16 may be linked together between the base 14 and the head assembly 18 to create additional degrees of movement. Further, fewer or more joints may be used at each joint (e.g., the connection between the base 14 and pivoting arm 16, or the connection between the pivoting arm and the head assembly 18).

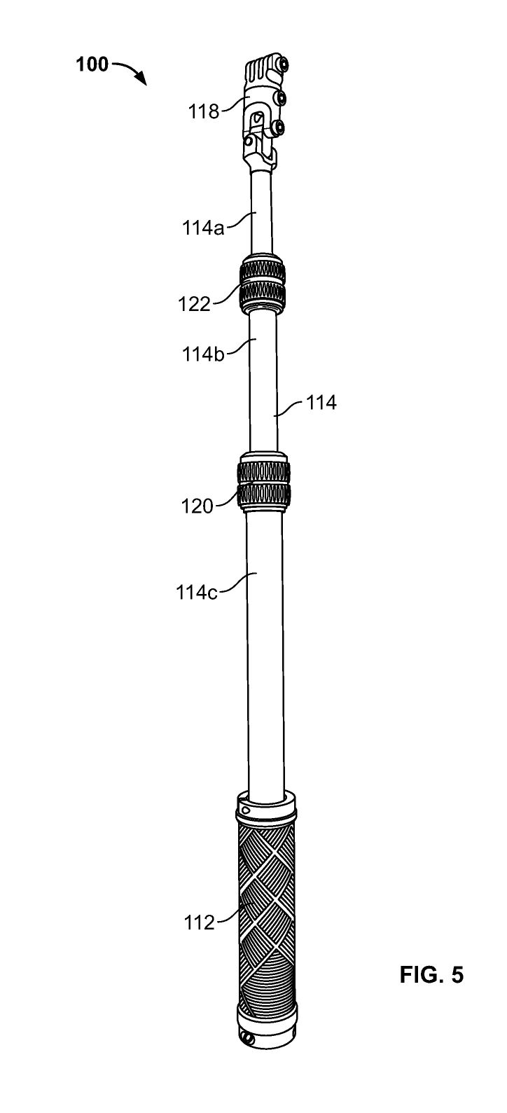

An example of an alternative monopod configuration mount 100 is depicted in FIG. 5. The mount 100 depicted in FIG. 5 includes a handle 112, an extending arm 114, and a head assembly 118. The handle 112 is similar to the modular handle 60 disclosed with reference to FIGS. 4A-C. The head assembly 118 is the same as the head assembly described above and depicted in FIGS. 1-3. However, the articulating arm 16 of FIG. 1 has been replaced by an extending arm 114. Rather than provide various degrees of movement, the extending arm 114 allows the user to adjust the length of the extending arm 114 to suit their particular needs. Two clamps 120, 122 may be rotated to loosen or tighten the clamps. When the clamps 120, 122 are loosened, the length of the extending arm 114 may be adjusted by moving the individual segment 114a in or out of individual segment 114b, and/or moving the individual segment 114b in or out of individual segment 114c, as is well understood in the art. When the clamps 120, 122 are tightened, the extending arm segments 114a and 114b are locked into place. The head assembly 118 then provides flexibility of positioning via the dual clevis-type configurations and the rotating, removable mount head described above. It should further be appreciated that in even further embodiments, the extending arm 114 may be combined with the articulating arm 16 so as to create an arm that is able to be extended and/or rotated at joints, combining the advantages of both embodiments.

Although the disclosure has been presented with reference only to the presently preferred embodiments, those of ordinary skill in the art will appreciate that various modifications can be made without departing from this disclosure. As such, the disclosure is defined only by the following claims and recited limitations.

1. A hand-held imaging device mount for mounting an imaging device, the mount comprising:
a handle configured to be held by a user;
a base connected to the handle;
an arm movably secured to the base such that the arm can be rotated relative to the handle and secured in place; and
a mount head movably secured to the arm such that the mount head can be moved relative to the arm and secured in place, the mount head configured to mount an imaging device, wherein
the imaging device mount permits an imaging device mounted to the mount head to be adjusted with multiple degrees of freedom relative to the handle.

2. The hand-held imaging device mount of claim 1, wherein the arm comprises a plurality of segments that are movably secured to each other to form the arm.

3. The hand-held imaging device mount of claim 1, wherein the handle comprises a high-friction material for assisting a user in holding the handle.

4. The hand-held imaging device mount of claim 3, the handle comprises a rubber material for assisting a user in holding the handle.

5. The hand-held imaging device mount of claim 1, wherein at least one of the arm and mount head is movably secured using a threaded fastener such that when the threaded fastener is loosened, the arm and/or mount head is movable, and when the threaded fastener is tightened, the arm and/or mount head is secured in place.

6. The hand-held imaging device mount of claim 1, wherein the mount head is configured to mount a GoPro camera.

7. The hand-held imaging device mount of claim 1, wherein the handle is removably connected to the base.

8. The hand-held imaging device mount of claim 7, wherein
the base comprises an elongated body,
the handle comprises
an opening shaped to receive the elongated body, and
a clamp to secure the handle to the base, and
the handle is removably connected to the base by inserting the elongated body into the opening and closing the clamp, and may be removed by opening the clamp.

9. A hand-held imaging device mount for mounting an imaging device, the mount comprising:
a handle configured to be held by a user;
an arm extending from the handle, the arm comprising a plurality of extending segments; and
a mount head movably secured to the arm such that the mount head can be moved relative to the arm and secured in place, the mount head configured to mount an imaging device, wherein
the plurality of extending segments may be extended relative to each other and secured in place.

10. A method for mounting an imaging device to a mount, the mount comprising
a handle configured to be held by a user,
a base connected to the handle,
an arm movably secured to the base such that the arm can be rotated relative to the handle and secured in place, and
a mount head movably secured to the arm such that the mount head can be moved relative to the arm and secured in place, the mount head configured to mount an imaging device,
the method comprising:
mounting an imaging device to a mount;
adjusting the position of the imaging device in a first direction by adjusting the position of the arm relative to the base;
adjusting the position of the imaging device in a second direction that is different from the first position by adjusting the position of the mount head relative to the arm; and
locking the imaging device in place.

11. The method of claim 10, wherein the arm comprises a plurality of segments that are movably secured to each other to form the arm.

12. The method of claim 10, wherein the handle comprises a high-friction material for assisting a user in holding the handle.

13. The method of claim 12 the handle comprises a rubber material.

14. The method of claim 10, wherein at least one of the arm and mount head is movably secured using a threaded fastener such that when the threaded fastener is loosened, the arm and/or mount head is movable, and when the threaded fastener is tightened, the arm and/or mount head is secured in place.

15. The method of claim 14, wherein locking the imaging device in place comprises tightening the threaded fastener.

16. The method of claim 10, wherein the mount head is configured to mount a GoPro camera.

17. The method of claim 10, wherein adjusting the position of the imaging device in a first direction by adjusting the position of the arm relative to the base comprises pivoting the arm relative to the base.

18. The method of claim 10, wherein adjusting the position of the imaging device in a second direction that is different from the first direction by adjusting the position of the mount head relative to the arm comprises pivoting the mount head relative to the arm.

19. The method of claim 10, wherein adjusting the position of the imaging device in a second direction that is different from the first position by adjusting the position of the mount head relative to the arm comprises rotating the mount head relative to the arm.

20. The method of claim 10, wherein
the base is removably connected to the handle
the base comprises an elongated body,
the handle comprises
an opening shaped to receive the elongated body, and
a clamp to secure to the handle to the base, and
the method further comprises:
loosening the clamp; and
removing the handle from the base.
